(19) United States
(12) Patent Application Publication
(10) Pub. No.: US 2009/0279839 A1
(43) Pub. Date: Nov. 12, 2009

(54) RECORDING/REPRODUCING DEVICE, RECORDING/REPRODUCING METHOD, RECORDING/REPRODUCING PROGRAM, AND COMPUTER READABLE RECORDING MEDIUM

(75) Inventors: Takeshi Nakamura, Saitama (JP); Toshio Tabata, Saitama (JP)

Correspondence Address: FOLEY AND LARDNER LLP;SUITE 500, 3000 K STREET NW, WASHINGTON, DC, 20007, US

(73) Assignee: Pioneer Corporation

(21) Appl. No.: 12/066,017

(22) PCT Filed: Aug. 21, 2006
(86) PCT No.: PCT/JP2006/316333

§ 371 Date: Mar. 6, 2008

(30) Foreign Application Priority Data
Sep. 7, 2005 (JP) 2005 259899

(51) Int. Cl. H04N 5/91; B60Q 1/00

(52) U.S. Cl. 386/46; 340/438

(57) ABSTRACT

A determining unit determines whether a vehicle is in a traveling state or a stopped state. When the determining unit determines that the vehicle is in the traveling state, an indicating unit indicates a timing of a point in the content to be reproduced. A specifying unit specifies a representative scene in the content that is in immediate proximity to the timing indicated by the indicating unit. When the determining unit determines that the vehicle is in the stopped state, a reproducing unit reproduces the representative scene.

### TECHNICAL FIELD

The present invention relates to a recoding and reproducing apparatus, a recording and reproducing method, a recording and reproducing program, and a computer-readable recording medium that reproduce highlights of a recorded content. However, use of the present invention is not limited to the recording and reproducing apparatus, the recording and reproducing method, the recording and reproducing program, and the computer-readable recording medium as above.

### BACKGROUND ART

Highlight reproduction is a method of reproducing a recorded content. With highlight reproduction, an overview of a recorded content can be grasped in a short time by extracting and reproducing highlights of the recorded content without viewing all the scenes thereof. Conventionally, detection of a highlight portion has been executed by analyzing information such as the level of the background sound, the presence or absence of caption information, and extracted keywords from sentences recognized by sound-recognition.

As a method of reproducing highlights, highlight points are designated by a viewer during a previous viewing and reproduction for a predetermined time period is repeated from each of the highlight points to thereby, reproduce the highlights (see, for example, Patent Document 1). Another such method sets, as a highlight section, a section spanning over a pre-set offset time period before and after the time at which a button is pressed by a viewer to set a highlight point during viewing (see, for example, Patent Document 2). Yet another method involves dividing a moving image into scenes based on cut points and detected audio/music sections, etc. and calculating an interest level for each scene by monitoring viewer behavior. Each section having an interest level that exceeds a threshold value is taken as a summarizing section (see, for example, Patent Document 3).

Patent Document 1: Japanese Patent Application Laid-Open Publication No. H11-273227

Patent Document 2: Japanese Patent Application Laid-Open Publication No. 2001-57660

Patent Document 3: Japanese Patent Application Laid-Open Publication No. 2004-159192

### DISCLOSURE OF INVENTION

### Problem to be Solved by the Invention

For safety reasons, a driver can not watch television while the vehicle is in motion. Nor can the driver watch highlight scenes of programs that are broadcasted while he/she is driving such as, for example, a homerun during a baseball game and the scoring of a goal during a soccer game. It is conceivable for the television program to be recorded simultaneously as the television program is received and when the vehicle is stopped, the driver operates the television to view a replay of the desired highlight scene. However, a problem exists in that, for example, to initiate this operation, very troublesome operation steps are required such as pressing a rewind button, searching for the desired scene, and pressing a replay button.

According to a conventional automatic highlight detecting technique, highlight detection is executed employing only an attribute level obtained from moving image information or associated sound information, or metadata appended to content as indicators, and information reflecting the intent of the viewer is not accessed. It has also been difficult to achieve complete detection of highlights by an automatic highlight reproducing technique itself. Therefore, a problem exists in that, for example, detection of a highlight, fully satisfying viewer demand, has been difficult to realize.

A problem also exists in that, for example, when a highlight is reproduced after a viewer has designated a highlight point, it is difficult to designate the correct starting position of the highlight event because the highlight event is designated after the highlight event has occurred, and the ending position of the highlight event is also not known unless the ending position is designated.

When a shot for which a viewer presses a button is determined to be a shot which the viewer is interested in, this designation does not significantly differ from designation of a highlight itself. Furthermore, when the degree of interest is calculated corresponding to the detected pressure exerted in pressing down the button, the speed of the pressing down the button, and consecutive manipulations of pressing down the button, button operation by the viewer is expected to correlate with the degree of interest in a shot, a purpose different from that of designating a highlight event according to button operation. In addition, a problem exists in that, for example, this technique evaluates each shot based on the value of the degree of interest and, therefore, the correct starting position and the correct ending position of a highlight event is not known.

### Means for Solving Problem

A recording and reproducing apparatus according to the invention of claim 1 includes a determining unit that determines whether a vehicle is in a traveling state or a stopped state; an indicating unit that indicates a given timing for the content that is to be reproduced when it is determined by the determining unit that the vehicle is in the traveling state; a specifying unit that specifies the range of the representative scene in the content at a position that is in immediate proximity to the timing indicated by the indicating unit; and a reproducing unit that reproduces the representative scene of the content that is designated with the range specified by the specifying unit when the determining unit determines that the vehicle is in the stopped state.

A recording and reproducing apparatus according to the invention of claim 6 includes an extracting unit that extracts a representative scene from content to be reproduced; an obtaining unit that obtains running information of a vehicle; an estimating unit that estimates a vehicle stop time of the vehicle based on the running information obtained by the obtaining unit; a shortening unit that shortens a representative scene of the content extracted by the extracting unit into a range of time that ends within the vehicle stop time estimated by the estimating unit; and a reproducing unit that reproduces the representative scene of the content shortened by the shortening unit.

A recording and reproducing apparatus according to the invention of claim 7 includes an indicating unit that indicates a given timing in content to be reproduced; a specifying unit that specifies a range of a representative scene of the content at a position immediately close to the timing instructed by the indicating unit; and an output unit that outputs the representative scene of the content designated in the range specified by the specifying unit, as a scene to be reproduced.

A recording and reproducing apparatus according to the invention of claim 8 includes a recording unit that records content to be reproduced; a reproducing unit that reproduces a representative scene of the content recorded by the recording unit; a determining unit that determines whether the content recorded in the recording unit includes the representative scene, when the recording unit records the content and the reproducing unit reproduces the representative scene; and a control unit that causes the recording unit to record the representative scene when the determining unit determines that the representative scene is included.

A recording and reproducing apparatus according to the invention of claim 9 includes a recording unit that records content to be reproduced; a detecting unit that detects the degree of importance of the content recorded by the recording unit; a specifying unit that specifies a range of a representative scene of the content based on the degree of importance detected by the detecting unit; and a reproducing unit that reproduces the representative scene of the content designated in the range specified by the specifying unit.

A recording and reproducing apparatus method according to the invention of claim 10 including a determining step of determining whether a vehicle is in a traveling state or a stopped state; an indicating step of indicating a given timing for the content that is to be reproduced when it is determined by the determining unit that the vehicle is in the traveling state; a specifying step of specifying the range of the representative scene in the content at a position that is in immediate proximity to the timing indicated by the indicating unit; and a reproducing step of reproducing the representative scene of the content that is designated with the range specified by the specifying unit when the determining unit determines that the vehicle is in the stopped state.

A recording and reproducing program according to the invention of claim 11 causes a computer to execute the recording and reproducing method according to claim 10.

A computer-readable recording medium according to the invention of claim 12 stores therein the recording and reproducing program according to claim 11.

### BRIEF DESCRIPTION OF DRAWINGS

FIG. 1 is a block diagram of the functional configuration of a recording and reproducing apparatus according to an embodiment of the present invention;

FIG. 2 is a flowchart of the process steps of a recording and reproducing method according to the embodiment of the present invention;

FIG. 3 is a block diagram of a functional configuration of the recording and reproducing apparatus;

FIG. 4 is a flowchart of a highlight recording process for an in-vehicle application;

FIG. 5 is a flowchart of a process executed in response to the detected state of the brake;

FIG. 6 is a diagram for explaining a vehicle stop time database;

FIG. 7 is a flowchart of a highlight detecting process;

FIG. 8 is a diagram for explaining the starting position and the ending position of each of highlight scenes;

FIG. 9 is a flowchart of a highlight reproduction process executed when a VICS/beacon is used;

FIG. 10 is a flowchart of a process of reproducing highlights based on hint information;

FIG. 11 is a flowchart of a highlight reproduction process that takes into account highlight detection between replays;

FIG. 12 is a block diagram of a functional configuration employed when a highlight scene and the degree of importance thereof are recorded in an HDD;

FIG. 13 is a flowchart of a process executed when a highlight scene and the degree of importance thereof are recorded into the HDD;

FIG. 14 is a diagram for explaining the starting position and the ending position of the highlight scene, and the degree of importance thereof; and

FIG. 15 is a flowchart of a highlight detecting process executed in response to an instruction of a highlight event.

### EXPLANATIONS OF LETTERS OR NUMERALS

101 determining unit
102 indicating unit
103 specifying unit
104 reproducing unit
301 antenna
302 tuner
303 IF circuit
310 image demodulating unit
311 image synthesizing unit
312 image output unit
313 A/D converting unit
314 image encoding unit
315 image decoding unit
316 image processing unit
317 D/A converting unit
319 bus
320 audio demodulating unit
321 audio selecting unit
322 audio output unit
323 A/D converting unit
324 audio encoding unit
325 audio decoding unit
327 D/A converting unit
330 attribute-level extracting unit
331 HDD
332 highlight detecting unit
333 control unit
334 operation unit
335 parking-brake-state detecting unit
336 VICS/beacon-information acquiring unit

### BEST MODE(S) FOR CARRYING OUT THE INVENTION

With reference to the accompanying drawings, exemplary embodiments of a recording and reproducing apparatus, a recording and reproducing method, a recording and reproducing program, and a computer-readable recording medium according to the present invention are explained in detail below.

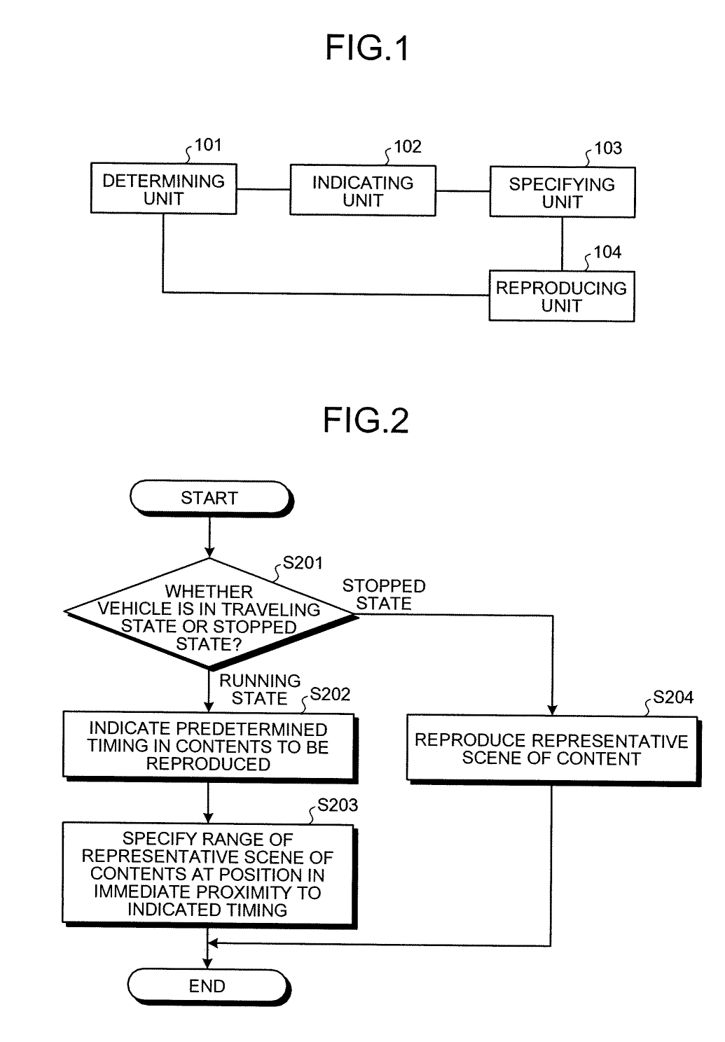

FIG. 1 is a block diagram of the functional configuration of a recording and reproducing apparatus according to an embodiment of the present invention. A recording and reproducing apparatus of the embodiment includes a determining unit 101, an indicating unit 102, a specifying unit 103, and a reproducing unit 104.

The determining unit 101 determines whether a vehicle is in a traveling state or a stopped state. For example, whether the vehicle is in the traveling state or the stopped state is determined based on the state of the parking brake. The indicating unit 102, when the determining unit 101 determines that the vehicle is in the traveling state, indicates a given timing in content that is to be reproduced. More specifically, a highlight event in the content is indicated.

The specifying unit 103 specifies the range of a representative scene in the content at a position that is in immediate proximity to the timing indicated by the indicating unit 102. More specifically, when the highlight event is indicated, the specifying unit 103 specifies the range of the highlight event in the content. The specifying unit 103 can also determine whether each scene included in the content is a characteristic scene, and specify a characteristic-scene section of a scene as the range of the representative scene.

The specifying unit 103 can also extract an attribute level of the content for each scene included in the content, and determine whether the scene is a characteristic scene based on the attribute level. The specifying unit 103 can also determine whether a scene after a position corresponding to a given time period preceding the timing indicated by the indicating unit 102 is included in a characteristic scene to specify the range of the representative scene.

The reproducing unit 104, when the determining unit 101 determines that the vehicle is in the stopped state, reproduces the representative scene of the content designated by the range specified by the specifying unit 103. More specifically, the reproducing unit 104 reproduces a highlight event for which the range is specified. The determining unit 101 can also record the time at which the vehicle stopped last and the reproducing unit 104 can also reproduce a highlight event that has occurred after the time of the last vehicle stop recorded by the determining unit 101.

This recording and reproducing apparatus can be configured such that the representative scene is extracted from the content to be reproduced; travel information of the car is obtained; a time period for which the vehicle will stop and a time when the time period will end are estimated based on the obtained travel information; the length of the extracted representative scene of the content is shortened to a time period that will end within the estimated time period for which the vehicle will stop; and the reproducing unit 104 reproduces the shortened representative scene of the content.

This recording and reproducing apparatus can also operate such that the indicating unit 102 indicates a given timing in the content to be reproduced; the specifying unit 103 specifies the range of the representative scene in the content at a position in immediate proximity to the timing indicated by the indicating unit 102; and the reproducing unit 104 outputs the representative scene designated by the range specified by the specifying unit 103.

This recording and reproducing apparatus can also operate such that the content to be reproduced is recorded in advance; the reproducing unit 104 reproduces the representative scene of the recorded content; while the content is being recorded and the reproducing unit 104 is reproducing the representative scene, the determining unit 101 determines whether the content being recorded includes a representative scene; and when the determining unit 101 determines that a highlight scene is included in the content, the representative scene is recorded.

This recording and reproducing apparatus can also be configured such that the content to be reproduced is recorded; the degree of importance of the recorded content is detected; the specifying unit 103 specifies the range of the representative scene of the content according to the detected degree of importance; and the reproducing unit 104 reproduces a highlight scene specified by the specifying unit 103.

FIG. 2 is a flowchart of the process steps of a recording and reproducing method according to the embodiment of the present invention. The determining unit 101 first determines whether the vehicle is in a traveling state or a stopped state (step S201). For example, whether the vehicle is in the traveling state or the stopped state is determined based on the state of the parking brake. When the determining unit 101 determines that the vehicle is in the traveling state (step S201: traveling state), the indicating unit 102 indicates a given timing in the content that is to be reproduced (step S202).

The specifying unit 103 specifies the range of the representative scene in the content at a position that is in immediate proximity to the timing indicated by the indicating unit 102 (step S203). The specifying unit 103 can also determine whether each scene included in the content is a characteristic scene, and specify a characteristic-scene section of a scene as the range of the representative scene.

The specifying unit 103 can also extract an attribute level of the content for each scene included in the content, and determine whether the scene is a characteristic scene based on the attribute level. The specifying unit 103 can also determine whether a scene after a position that corresponds to a given time period preceding the timing indicated by the indicating unit 102 is included in a characteristic scene to specify the range of the representative scene. After this specifying, a series of processing ends.

When the determining unit 101 determines that the vehicle is in the stopped state (step S201: stopped state), the reproducing unit 104 reproduces the representative scene designated by the range specified by the specifying unit 103 (step S204). A series of processing ends.

The above embodiment enables indication of a given timing while the vehicle is in motion, and reproduction of a representative scene, such as a highlight scene, while the vehicle is in the stopped state. Hence, viewing of the content can be supported in a manner that is not disruptive to the driving of the driver. Because only a highlight event after the previous stopping of the vehicle is reproduced by recording the time at which the car stopped, of multiple reproductions of the same representative scene can be prevented.

### EXAMPLES

### First Example

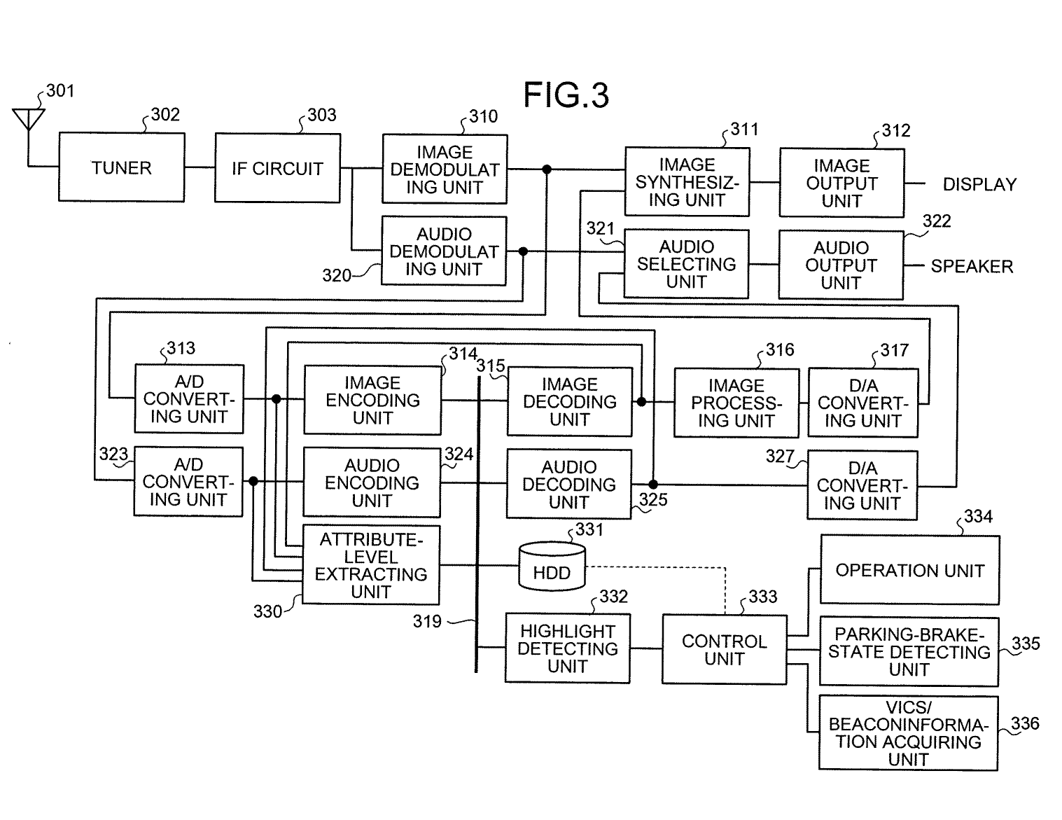

FIG. 3 is a block diagram of a functional configuration of the recording and reproducing apparatus. A television wave is received through an antenna 301. In this case, a tuner 302 is operated to select and tune into a station and, thereby, receive a signal including audio and image from the antenna 301. An IF circuit 303 separates the signal into an image signal and an audio signal.

An image demodulating unit 310 demodulates the image signal and an audio demodulating unit 320 demodulates the audio signal. The image signal and the audio signal that are demodulated are converted, respectively, into digital signals by A/D converting units 313 and 323, respectively. Image data and audio data obtained by converting the image signal and the audio signal into the digital signals are input respectively into an image encoding unit 314 and an audio encoding unit 324. The image data and the audio data are both input into an attribute-level extracting unit 330. The image data and the audio data are input respectively into an image processing unit 316 and a D/A converting unit 327.

The image encoding unit 314, an image decoding unit 315, the audio encoding unit 324, an audio decoding unit 325, the attribute-level extracting unit 330, an HDD 331, and a highlight detecting unit 332 are connected by a bus 319 to each other. The HDD 331 is a hard disk drive. The HDD 331 records content and includes a highlight scene database and a stop time database that stores the time at which the vehicle stops.

The image encoding unit 314 compresses the digitalized image data, and thereby, content having a long time period is recorded to the HDD 331. MPEG-2 is a standard compressing method. However, when an encoding method having a higher compression rate is selected, the use of, for example, MPEG-4, ITU-T_H.264, etc., can be considered. The image decoding unit 315 reads and decodes the encoded image data recorded in the HDD 331. The image decoding unit 315 sends the decoded image data to the image processing unit 316 for image processing and to the attribute-level extracting unit 330. After the image processing unit 316 processes the image data, the D/A converting unit 317 converts the image data into an analog signal and inputs the converted signal into an image synthesizing unit 311. The image synthesizing unit 311 selects either the input from the D/A converting unit 317 or the input from the image demodulating unit 310 and outputs the selected input to an image output unit 312. The image output unit 312 outputs the video image signal to a display.

The audio encoding unit 324 compresses and encodes the audio data similarly to the image data. MPEG-1_Layer2, MPEG-1_layer3 (MP3), MPEG-2_AAC, Dolby_AC3, etc., can be considered as an encoding scheme. An audio decoding unit 325 decodes the encoded audio data recorded in the HDD 331. The decoded audio data is converted into an analog signal by a D/A converting unit 327 and input into an audio selecting unit 321. The audio selecting unit 321 selects either the input from the D/A converting unit 327 or the input from the audio demodulating unit 320 and outputs the selected input to an audio output unit 322. The audio output unit 322 outputs the audio signal to a speaker.

The attribute-level extracting unit 330 detects an attribute level from the image data or the audio data. This attribute level is a parameter necessary for detecting a highlight, i.e., an important portion that is meaningful, from moving image content. An attribute level to be extracted can be, for example, a scene change, movement information, camerawork, a caption, an audio level, and text generated by sound recognition of sound data. Data indicating such attributes of an image or audio is extracted and the level thereof is obtained to extract the attribute level. The information including the image or the audio, or both is referred to as content and content may be that of a television program, only images thereof, or only audio thereof.

A highlight detecting unit 332 extracts, using the attribute level extracted by the attribute-level extracting unit 330, a highlight portion from moving image content that includes the image data and the audio data. Various methods can be considered as an approach for detecting the highlight and a method can be considered of detecting a highlight section by using a section having a high sound level or a section without sound.

A control unit 333 records, based on the detection result by the highlight detecting unit 332 and output respectively from an operation unit 334, a parking-brake-state detecting unit 335, and a VICS/beacon-information acquiring unit 336, information concerning the highlight scene into the HDD 331.

The operation unit 334 receives operation instructions from the viewer such as instructions for a highlight event, replay execution, and start of digest reproducing. In addition to physical operation of a device such as a remote control, a button, a keyboard, or a mouse, the use of a user interface such as sound recognition and gesture recognition can also be considered for the operation of the operation unit 334. Additionally, according to application, various operating methods can be used.

The parking-brake-state detecting unit 335 detects the fixed state and the released state of the parking brake of the vehicle, and controls the display state of the image on the display according to the state of the parking brake. Typically, a television device installed in a vehicle has a specification requiring that viewing thereof be restricted when the vehicle is not in the stopped state, the stopped state being the state in which the parking brake is pulled; thereby, preventing the occurrence of an accident caused by the driver paying attention to the television device while driving. That is, while the vehicle is in motion, the television screen is turned off and only the audio is output.

According to the above configuration, a highlight event instruction by the viewer is received while the car is in motion and replay of the highlight scene is executed while the car is stopped. This processing described.

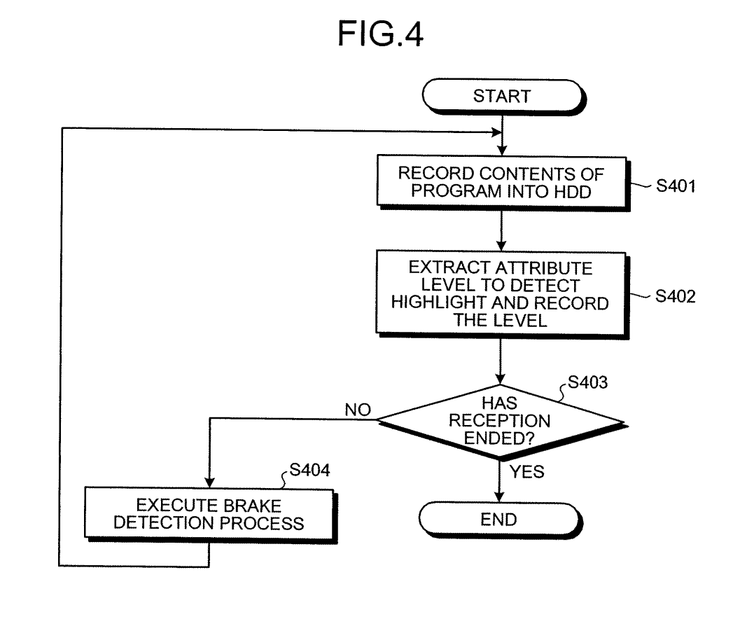

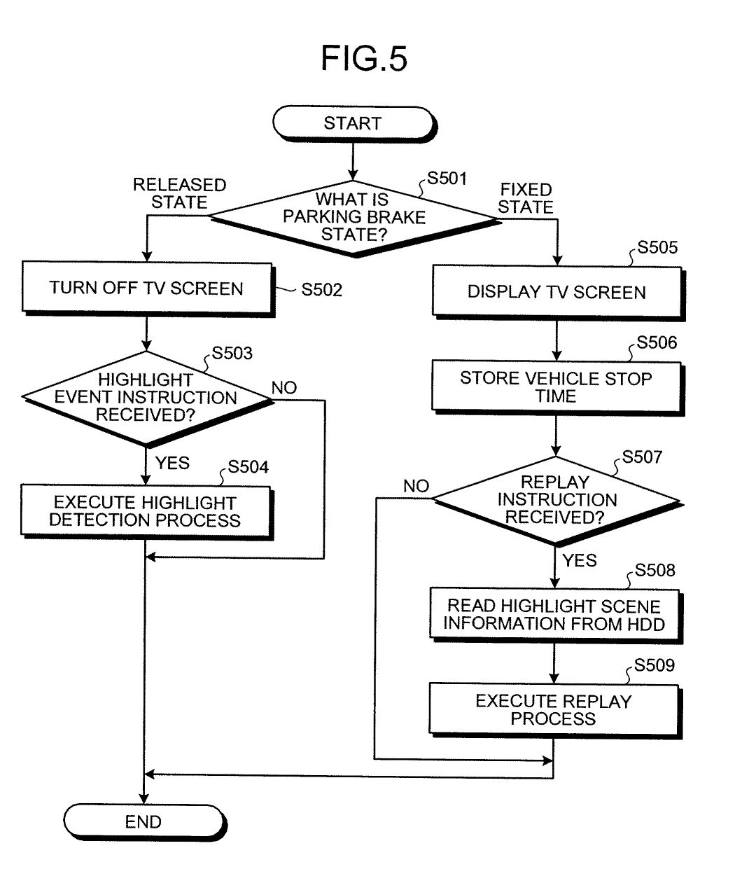

FIG. 4 is a flowchart for explaining a highlight recording process for an in-vehicle application. Simultaneously with the reception of the program, the content of the program is recorded into the HDD 331 (step S401). During the recording of the content of the program, the attribute level used to detect the highlight is extracted and recorded into the HDD 331 (step S402). The attribute level to be recorded depends on the highlight detection algorithm and the highlight detection algorithm is not particularly limited. Whether the reception has ended is determined (step S403). When the reception has ended (step S403: YES), a series of processing comes to an end. When the reception has not ended (step S403: NO), the apparatus executes processing in response to a detected state of the brake, shown in FIG. 5 (step S404).

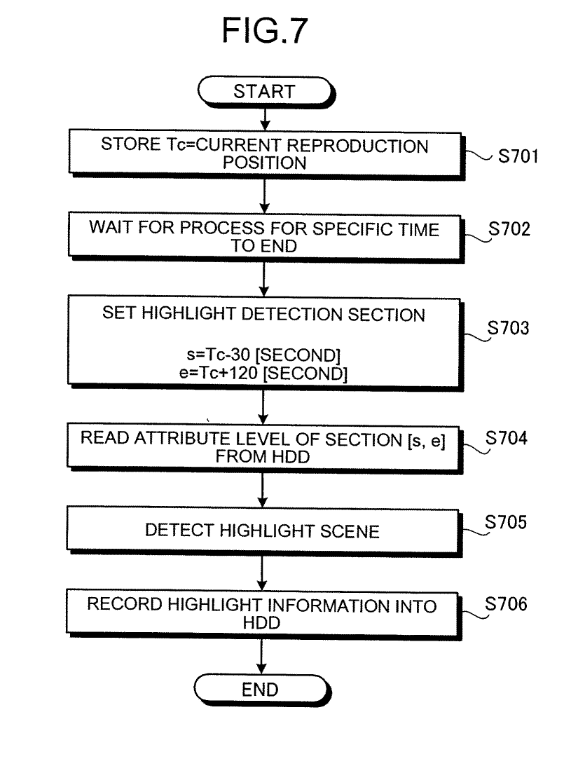

FIG. 5 is a flowchart for explaining a process executed in response to the detected state of the brake. The state of the parking brake is first determined (step S501). When the parking brake is in the released state (step S501: released state), the television screen is turned off (step S502). Whether instruction for the highlight event has been received is determined (step S503). When no instruction for the highlight event has been received (step S503: NO), the series of processing comes to an end. When an instruction for the highlight event has been received (step S503: YES), the highlight detecting process shown in FIG. 7 are executed (step S504) and the series of processing comes to an end.

When the viewer, based on the audio, determines that a highlight event has occurred while driving, the viewer indicates the highlight event. Although indication of the highlight event by the viewer is not limited to a particular form, an operation method using a remote control or sound-recognition can be considered; thereby, minimally affecting the driver.

On the other hand, when it is determined that the state of the parking brake is the fixed state (step S501: the fixed state), the television screen is displayed (step S505). In this case, the output of the television audio is also continued. Because the vehicle is in the stopped state, the time at which the vehicle is stopped is stored in a vehicle stop time database (step S506). Whether a replay instruction has been received is determined (step S507). When no replay instruction has been received (step S507: NO), the series of processing comes to an end.

When a replay instruction has been received (step S507: YES), highlight scene information obtained after the time of the vehicle's previous stop is read from the HDD 331 by checking the car stop time database (step S508). A replay process is executed (step S509); thereby, enabling a highlight scene of the program occurring after the time of the vehicle's previous stop to be enjoyed within a short time. After the replaying, the series of processing comes to an end.

According to the processing above, the highlight instructed by the viewer is replayed after it is confirmed that the viewer has pulled the parking brake and the vehicle is stopped. Hence, in a short period of time, the viewer can enjoy a digest of a program on the television screen. The start of the replay may be initiated by a replay start instruction by the viewer or may be configured as an automatic replay start interlocked with the parking brake.

The vehicle stop time database for managing the vehicle stop time is provided and, thereby, enabling the replay to be automatically started by an interlock with the parking brake, i.e., the replay can be automatically started when the parking brake is changed to the fixed state. The time at which the vehicle stops is managed in a database. Hence, the highlight after the previous stop of the vehicle can be replayed to a point instructed by the viewer. The highlights before the previous stop time of the vehicle can be considered to have been viewed at stops preceding the previous stop. That is, a digest of a requisite minimum can be realized by managing the time of the stops.

The method of detecting the stopped state of the vehicle by detecting the state of the parking brake is a common method for restricting the viewing a television device installed therein. However, approaches such as checking whether the position of the key of the vehicle is in the stop state; the speedometer; detection of a vehicular speed pulse; and an acceleration sensor can be employed. Although the replay of the highlight scene may be started by an instruction by the viewer, the replay may be automatically started by being interlocked with the parking brake, i.e., the replay may be automatically initiated when the parking brake is changed to the fixed state. Although the highlight scene to be replayed is that obtained after the time of the previous vehicle stop, configuration may be such that all of highlight scenes are reproduced.

Thereby, support for viewing a television device installed in a vehicle can be realized such that operation of the vehicle by the viewer is not disrupted. The highlight scene obtained after the time of the previous vehicle stop alone can be replayed by using the vehicle stop time database and, thereby, eliminating overlapping highlight replay.

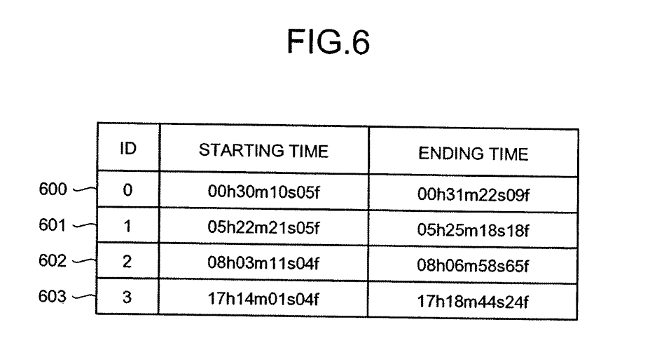

FIG. 6 is a diagram for explaining the vehicle stop time database. The starting time and the ending time of each stop time are recorded respectively with a corresponding ID. Data 600 to 603 are assigned IDs 0 to 3, respectively, and record a starting time and an ending time. For subsequent vehicle stop times, the starting time and the ending time can be recorded by preparing IDs as 4, 5, etc.

The data 600 is recorded corresponding to the ID 0 and the starting time thereof is 00h30m10s05f. The ending time thereof is 00h01m12s04f. The data 601 is recorded corresponding to the ID 1 and the starting time thereof is 05h22m21s05f. The ending time thereof is 00h02m57s13f. The data 602 is recorded corresponding to the ID 2 and the starting time thereof is 08h03 m11s04f. The ending time thereof is 00h03m47s01f. The data 603 is recorded corresponding to the ID 3 and the starting time thereof is 17h14m01s04f. The ending time thereof is 00h04m43s20f.

FIG. 7 is a flowchart for explaining a highlight detecting process. “Tc” is stored as a current reproducing position (step S701). A process, for a specific time, is waited for to end (step S702). Thereby, the start of the highlight detecting process is delayed. By delaying the start, the end of a highlight event is waited for and the starting time and the ending time of the highlight can be detected.

A highlight detection section is set (step S703). In this case, the starting time of the highlight detection is denoted by “s” and the ending time of the highlight detection is denoted by “e”. As to the highlight detection section, it is assumed, for example, s=Tc-30 sec and e=Tc-120 sec. These lengths can each be variously set according to the application.

The attribute level of section [s, e] is read from the HDD 331 (step S704). A highlight scene is detected based on the read attribute level (step S705). In this case, the highlight detecting algorithm is not particularly limited. The highlight information is recorded into the HDD 331 (step S706). More specifically, the starting position and the ending position are recorded into a database. After this recording, the series of processing comes to an end.

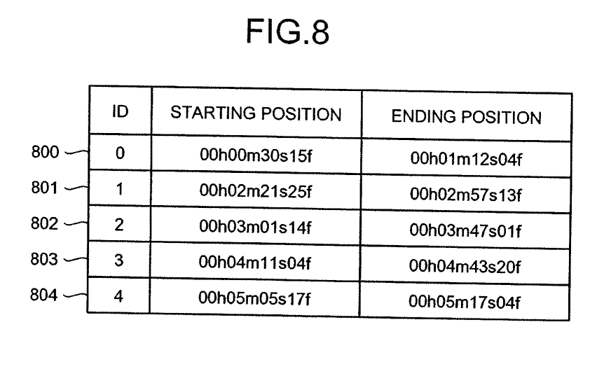

FIG. 8 is a diagram for explaining the starting position and the ending position of each of highlight scenes. The starting position and the ending position of each highlight scene are recorded respectively with a corresponding ID. Data 800 to 804 are assigned IDs 0 to 4, respectively, and record a starting time and an ending time. For subsequent highlight scenes, the starting position and the ending position can be recorded by preparing IDs as 5, 6, etc. Hence, the ID number is incremented by one each time a new highlight scene is detected. FIG. 8 shows an example of the highlight scene information detected as above. An ID thereof is a reference numeral that is given to identify each highlight scene. The ending time may be recorded in the form of the duration of a highlight scene.

The data 800 is recorded corresponding to the ID 0 and the starting position thereof is 00h00m30s15f. The ending position thereof is 00h01m12s04f. The data 801 is recorded corresponding to the ID 1 and the starting time thereof is 00h02m21s25f. The ending time thereof is 00h02m57s13f. The data 802 is recorded corresponding to the ID 2 and the starting time thereof is 00h03m01s14f. The ending time thereof is 00h03m47s01f. The data 803 is recorded corresponding to the ID 3 and the starting time thereof is 00h04 m11s04f. The ending time thereof is 00h04m43s20f. The data 804 is recorded corresponding to the ID 4 and the starting time thereof is 00h05m05s17f. The ending time thereof is 00h00m00s00f.

The detection of a highlight scene can be realized by recording an attribute level in the HDD 331 and using the recorded attribute level. However, in addition, a highlight scene can also be detected by detecting candidate highlight scenes and the degree of importance thereof, recording these scenes in the HDD 331, and using the scenes. The highlight detecting process steps may be replaced by the portion that will be described for a fifth embodiment described hereinafter. Thereby, data to be recorded in the HDD 331 necessary for the highlight detection can be reduced.

As above, the first embodiment enables, while a vehicle is in motion, a driver to determine that a scene of a program is a highlight scene by listening to the sound of the program and, by designating a timing in the program, to specify a range of the highlight scene in the content at a position in immediate proximity to the timing. Conventionally, the range is determined using the designated time as the starting point and another designated time as the ending point, and hence, the actual range of the highlight scene can not be specified. Especially, while the vehicle is in motion, the driver concentrates on driving and, therefore, the designated timing and the actual starting time point of a highlight scene do not always coincide. On the contrary, the range can be accurately specified because the highlight scene is specified using the designated timing as hint information.

For safety reasons, the viewer is not able to view a program itself or a highlight scene thereof while driving. Hence, there is a need to catch the gist of the program while the vehicle is in the stopped state. Therefore, the highlight scene is reproduced while the vehicle is in the stopped state. When the driver views, for example, a sport program, by viewing highlight scenes that follow the progress of the game, the driver can view important portions of the program that could not be viewed while driving.

### Second Embodiment

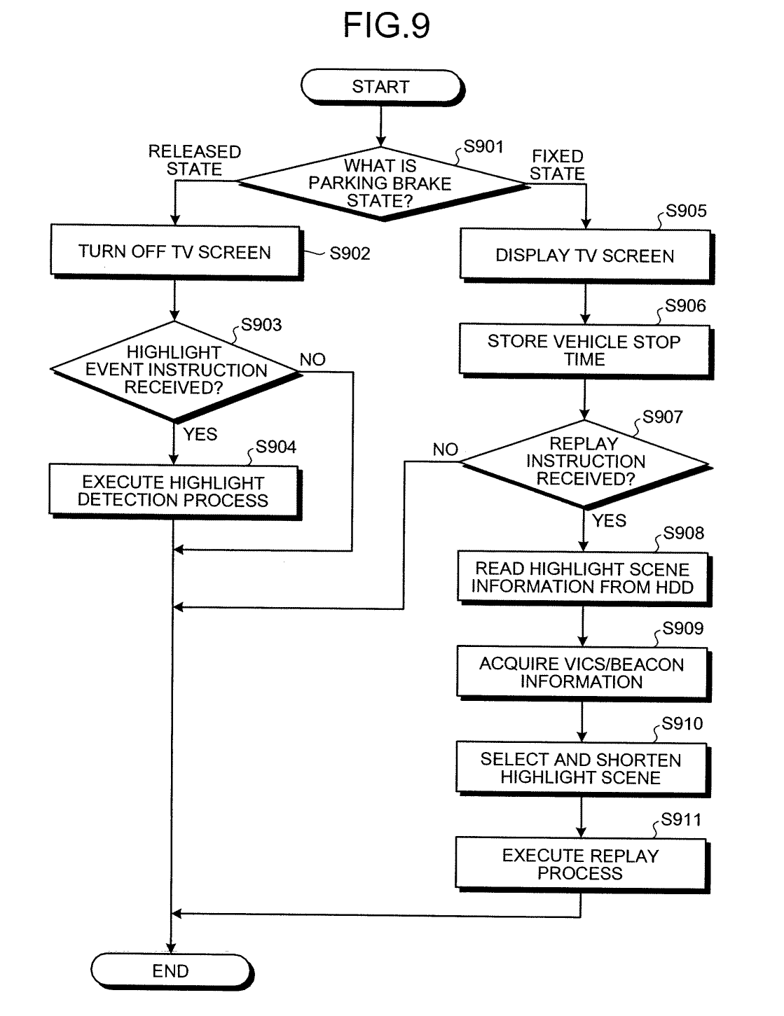

FIG. 9 is a flowchart for explaining a highlight reproduction process executed when a VICS/beacon is used. The highlight reproduction process according to a second embodiment can be executed in the recording and reproducing apparatus shown in FIG. 3. The state of the parking brake is first determined (step S901). When the parking brake is in the released state (step S901: released state), the television screen is turned off (step S902). Whether instruction for the highlight event has been received is determined (step S903). When no instruction for the highlight event has been received (step S903: NO), the series of processing comes to an end. When an instruction for the highlight event has been received (step S903: YES), the highlight detecting process shown in FIG. 7 are executed (step S904) and the series of processing comes to an end.

On the other hand, when the parking brake is in the fixed state (step S901: fixed state), the television screen is displayed (step S905). Because the vehicle has entered the stopped state, the vehicle stop time at this time is stored (step S906). Whether a replay instruction has been received is determined (step S907). When no replay instruction has been received (step S907: NO), the series of processing comes to an end. When a replay instruction has been received (step S907: YES), the highlight scene information is read from the HDD 331 (step S908). The VICS/beacon information is obtained and estimation of a vehicle stop period is executed based on the information (step S909). In response to this estimated vehicle stop period, a highlight scene is selected and shortened (step S910). The replay process is executed (step S911) and the series of processing comes to an end.

According to the processing above, when the replay time necessary for the replay target is longer than the estimated vehicle stop period: (1) the highlight scene to be replayed is selected according to, for example, chronological order or the degree of importance, and the remaining highlight scenes are replayed during the next vehicle stop period; (2) the respective time lengths of the highlight scenes to be replayed are uniformly shortened to adjust the total replay time to be within the vehicle stop period; and (3) the respective time lengths of the highlight scenes to be replayed are shortened according to degree of importance, beginning from the least important, to adjust the total replay time to be within the vehicle stop period.

As described above, according to the second embodiment, the VICS/beacon, etc., obtains travel information of the vehicle and based on the obtained travel information, estimates the stop period of the vehicle. More specifically, the vehicle stop period is the waiting time for a traffic signal to change at an intersection, the vehicle stop period due to traffic congestion, etc. The highlight scene is selected and shortened to correspond with the estimated vehicle stop period, thereby assuring that the replay is finished within the vehicle stop period of the vehicle. Although operation of the vehicle causes the vehicle to recursively stop and go, within the vehicle stop period, the driver is able to finish viewing the scenes that could not be viewed while the vehicle was in motion, i.e., without starting operation of the car again before finishing viewing the scenes. As a result, the next time the car travels and stops, scenes prior to the previous stop do not need to be reproduced and thereby, preventing a delay in replaying the scenes to be viewed.

### Third Embodiment

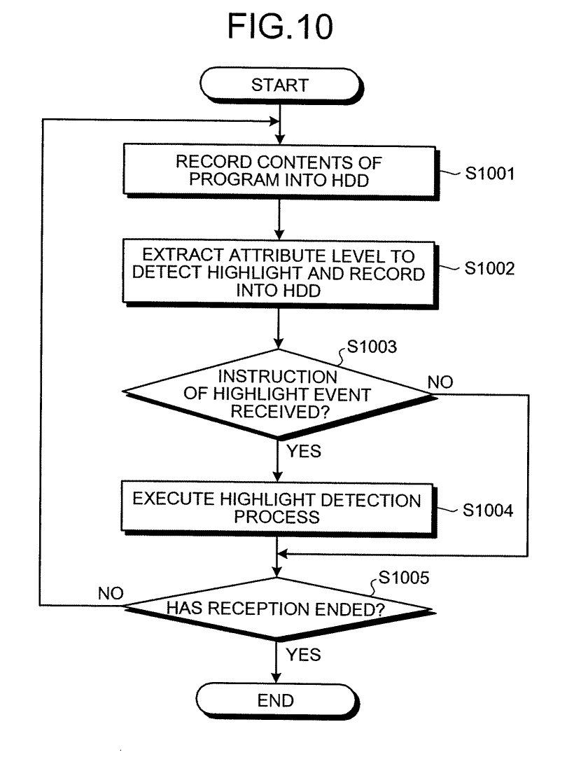

FIG. 10 is a flowchart for explaining a process of reproducing highlights based on the hint information. The highlight reproduction process according to a third embodiment can be executed by the recording and reproducing apparatus shown in FIG. 3. The content of a program are recorded in the HDD 331 (step S1001). An attribute level for detecting a highlight is extracted and recorded in the HDD 331 (step S1002). Whether an instruction of a highlight event has been received is determined (step S1003). When an instruction of a highlight event has been received (step S1003: YES), the highlight detecting process steps shown in FIG. 7 are executed (step S1105).

When no instruction for a highlight event has been received (step S1003: NO) or, after the highlight detecting process comes to an end, whether reception of the program has finished is determined (step S1005). When the reception has not finished (step S1005: NO), the process returns to step S1001 and the process is re-started. When the reception has finished (step S1005: YES), the series of processing comes to an end.

That is, simultaneously with the reception of the program, an attribute level used to detect the highlight scene is extracted and recorded in the HDD 331. In response to a highlight instruction by the viewer, the attribute level of a predetermined highlight detection section is read from the HDD 331 and the highlight is detected. The ending time of the highlight scene is detected. Thereby, the ending time of the highlight scene is detected using the highlight event instruction by the viewer as the hint information for automatic detection of the highlight scene.

According to the processing above, the highlight scene can be securely detected even when the highlight event instruction by the viewer is vague. Because the ending time of the highlight scene is also detected, no replay ending instruction by the viewer is necessary and automatic ending of the replay is possible when, for example, the highlight scene is replayed. Automatic repeating of the highlight scene is also enabled.

In the automatic detection of the highlight scene, a problem can be listed in that detection that fully reflects viewer intent is difficult. However, the occurrence of a highlight event is indicated by the viewer and the highlight scene is detected using the indication as a hint. Hence, by detecting the highlight in this manner, reproduction is executed in a short period of time, reproduction including highlight reproduction, summarized reproduction, and digest reproduction by the automatic replay of the highlight scene(s) or reproduction of only the highlight scene(s).

It can also be considered for the viewer to indicate the highlight event, and to record and use the content indicated. However, a problem can be firstly listed in that an accurate highlight scene ending time can not be obtained with only these steps because the viewer can indicate the highlight event only after the highlight event has occurred. Another problem can be secondly listed in that the viewer can not indicate the highlight ending time and even when the viewer can indicate the ending time, the burden of the instruction operation is imposed on the viewer and operation becomes less accurate.

As described above, according to the third embodiment, the viewer is caused to indicate the highlight event and the indication by the viewer is used as hint information for automatic detection of the highlight scene. That is, a highlight scene reflecting viewer intent can be specified by the instruction of the viewer, and specification of an accurate highlight scene by a single button operation is enabled by supplementing the imprecise viewer indication with a highlight detecting process and thereby, troublesome operations therefor can be eliminated.

By using the obtained highlight information, the highlight can be reproduced. That is, the highlights of the entire program can be reproduced by sequentially reproducing the detected highlight scenes in chronological order; thereby, enabling utilization the entire program to help understand the content thereof in a short period of time or judging whether the viewer is interested therein.

A highlight scene that is close to the instructed time is detected in response to the highlight event instruction from the viewer. However, the detection condition for the detected highlight scene may be stored and, afterwards, the highlight scene may be automatically determined when a highlight scene that is close to the stored condition is detected.

### Fourth Embodiment

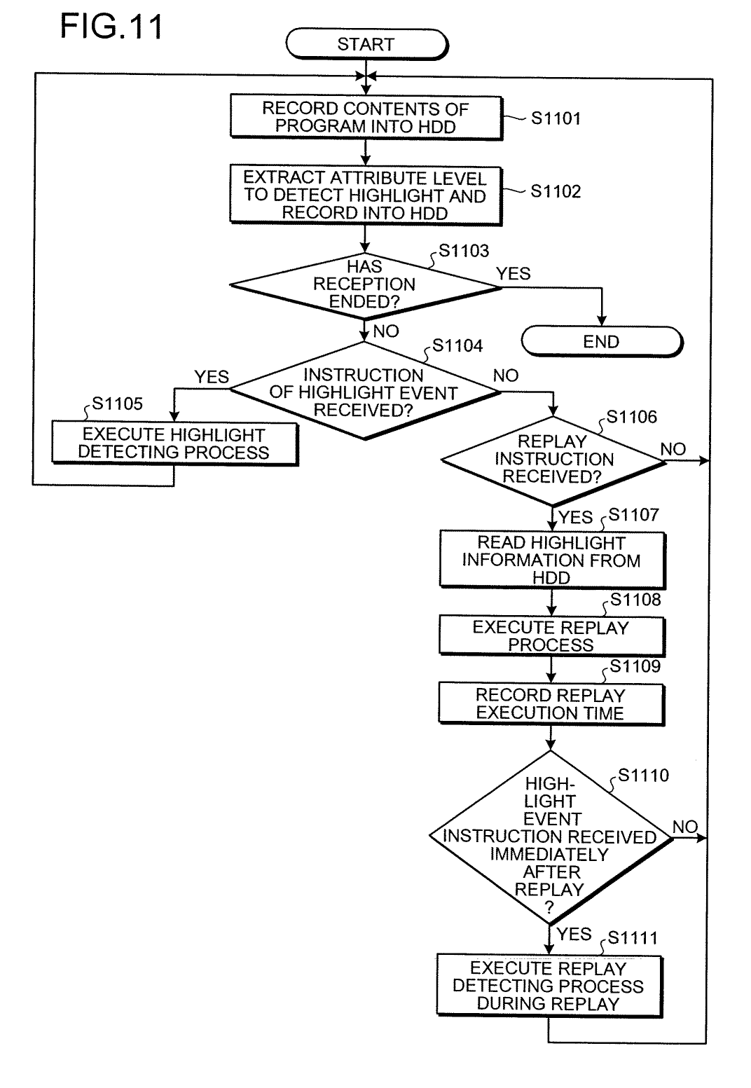

FIG. 11 is a flowchart for explaining a highlight reproduction process that takes into account highlight detection between replays. The highlight reproduction process can be executed by the recording and reproducing apparatus shown in FIG. 3. The content of a program are recorded in the HDD 331 (step S1101). An attribute level for detecting a highlight is extracted and recorded in the HDD 331 (step S1102). Whether reception has ended is determined (step S1103). When the reception has ended (step S1103: YES), the series of processing comes to an end.

When the reception has not ended (step S1103: NO), whether an instruction of a highlight event has been received is determined (step S1104). When an instruction of a highlight event has been received (step S1104: YES), the highlight detecting process steps shown in FIG. 7 are executed (step S1105) and the process returns to step S1101. When no instruction of a highlight event has been received (step S1104: NO), whether a replay instruction has been received is determined (step S1106).

When no replay instruction has been received (step S1106: NO), the process returns to step S1101. When a replay instruction has been received (step S1106: YES), the highlight scene information is read from the HDD 331 (step S1107). In this case, the highlight scene to be replayed can be considered to be one of various cases such as an immediately-preceding highlight scene, a highlight scene after the previous replay instruction, and all of the highlight scenes. When a highlight scene after the previous replay instruction is determined, this is enabled by using the information in a replay execution time database.

The replay process is executed (step S1108). In this case, the time at which the replay is viewed is recorded in the replay time execution time database, i.e., the time during which a television program that can not be viewed in real-time due to the execution of replay (step S1109). This example is as shown in FIG. 6. The format of this database is same as that of the vehicle stop time database described in the first embodiment. Whether a highlight event instruction has been received immediately after the replay is determined (step S1110). The timing of “immediately after the replay” is within one minute after the viewing of the replay has ended. However, this time length can be set to be the length corresponding to the application.

When no instruction has been received (step S1110: NO), the process returns to step S1101. When an instruction has been received (step S1110: YES), a during-replay highlight detecting process is executed (step S1111). This highlight scene detecting process is basically same as the highlight detection process shown in FIG. 7. This process differs in that the highlight detection section is changed from the replay execution time database to the previous replay viewing starting time/ending time. After this process, the process returns to step S1101.

The during-replay highlight detecting process is described. In the case where a highlight event occurs during the replay, at the time when the viewer has finished the replay and returns to ordinary television viewing, the viewer guesses that some highlight event has occurred. For example, this is the case in which some change is present compared to the state before the start of the replay. Examples of this change can be (1) a change in the score of a sports program, (2) a change in a story, i.e., the flow of a story can not be grasped for a movie or a drama, and (3) a change in information of a program such as, characters, the location, the time of day, and the weather. When a highlight event is instructed immediately after the replay is finished, for example, within one minute, the apparatus determines that this instruction instructs detection of a highlight that may have occurred while the replay was being viewed and the apparatus detects the highlight scene from the section.

A replay method can be considered involving detection of a highlight scene according to a viewer highlight event instruction associated with the replay function of highlight scenes and playing of an immediately preceding highlight scene, a highlight scene after the previous replay instruction, and all highlight scenes according to a replay instruction by the viewer. However, in this case, a problem may arise in that the viewer fails to view a highlight event occurring while the replay is being viewed.

On the other hand, a method is present of employing a two-screen display technique or a picture-in-picture (PinP) technique and using one screen to display the television program in real time and the other screen to display a replay screen. Thereby, the viewer is able to view the television program in real time. However, a problem can be listed in that additional hardware is necessary to realize the above and the cost of the product is increased. Hence, realizing the above function at a minimal cost is desired.

The detection of a highlight event occurring while the viewer is viewing the replay is executed according to a highlight event instruction received immediately after the replay and, in addition, the highlight event occurring while the viewer is viewing the replay may be automatically detected after the viewing of the replay. The detection of a highlight event can also be realized by recording an attribute level in the HDD 331 and using the recorded attribute level. However, in addition, a candidate highlight scene and the degree of importance thereof are detected and recorded in the HDD 331, and may be used to detect the highlight scene. The highlight detecting process may be a process other than the process described with reference to FIG. 7 and may be replace with a process described in a fifth embodiment described below. As a result, the data to be recorded in the HDD 331 that is necessary for detecting a highlight can be reduced.

As described above, according to the fourth embodiment, a viewer can view a highlight scene that the viewer had missed while viewing a replay. The viewer can easily issue an instruction for the highlight scene. By recording a replay execution time, a highlight event occurring during the previous stopping of the vehicle alone is replayed and repeated replaying of the highlight scene can be prevented.

### Fifth Embodiment

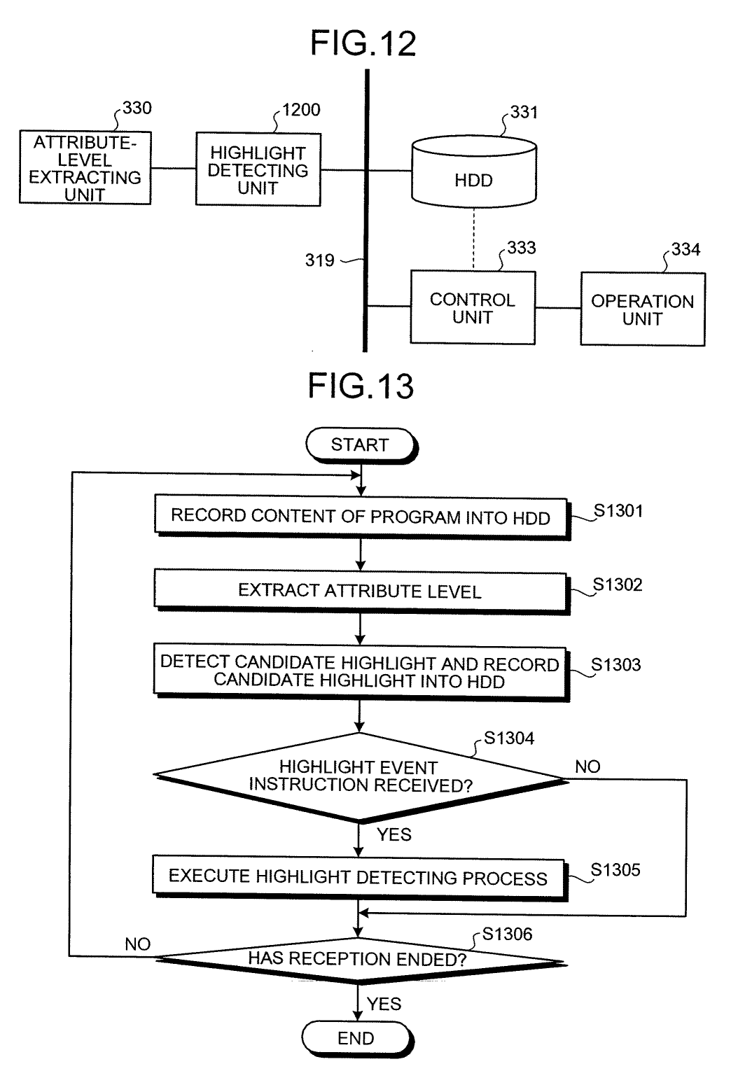

FIG. 12 is a block diagram for explaining the functional configuration employed when a highlight scene and the degree of importance thereof are recorded in the HDD 331. The configuration of each of the attribute-level extracting unit 330, the HDD 331, the control unit 333, and the operation unit 334 is same as the configuration shown in FIG. 3 and FIG. 12 describes only a portion of the bus connection shown in FIG. 3. Other configurations are the same as that of FIG. 3. The attribute-level extracting unit 330 is input with output respectively from the A/D converting unit 313 and 323, the image decoding unit 315, and the audio decoding unit 325.

An attribute level extracted by the attribute-level extracting unit 330 is input into a highlight detecting unit 1200. The highlight detecting unit 1200 detects a highlight scene and records the scene into the HDD 331. Meanwhile, the control unit 333 reads the highlight scene from the HDD 331 based on the input from the operation unit 334 and the image decoding unit 315 and the audio decoding unit 325 shown in FIG. 3.

The highlight detecting unit 1200 is disposed subsequent to the attribute-level extracting unit 330. In this case, a highlight portion is detected from moving image content using the attribute level extracted by the attribute-level extracting unit 330 and the degree of importance of a highlight section thereof is simultaneously calculated. In this case, assuming that the highest degree of importance is indicated as 100 and the lowest degree of importance is indicated as 0, a degree of importance is indicated by an integer value between 100 and 0. The method of indicating a degree of importance is not limited to this and various methods can be considered. In terms of a specific method of detecting a highlight, any method can be used.

FIG. 13 is a flowchart for explaining a process executed when a highlight scene and the degree of importance thereof are recorded into an HDD. The content of a program is recorded into the HDD 331 (step S1301). The recording of the content of the program is executed simultaneously with the reception of the program. An attribute level is extracted (step S1302). The extracted attribute level is stored in a memory (not shown) and is not recorded in the HDD 331. However, the attribute level to be stored sufficiently corresponds to the required time for detecting the highlight, and the required memory capacity depends on the application used.

A candidate highlight is detected and is recorded in the HDD 331 (step S1303). In this case, the candidate highlight is recorded into a highlight scene database in the HDD 331. More specifically, the starting position and the ending position of the highlight scene, and the degree of importance of the detected highlight scene are calculated. The starting position and the ending position, and the degree of importance of the highlight scene are collectively recorded in the database.

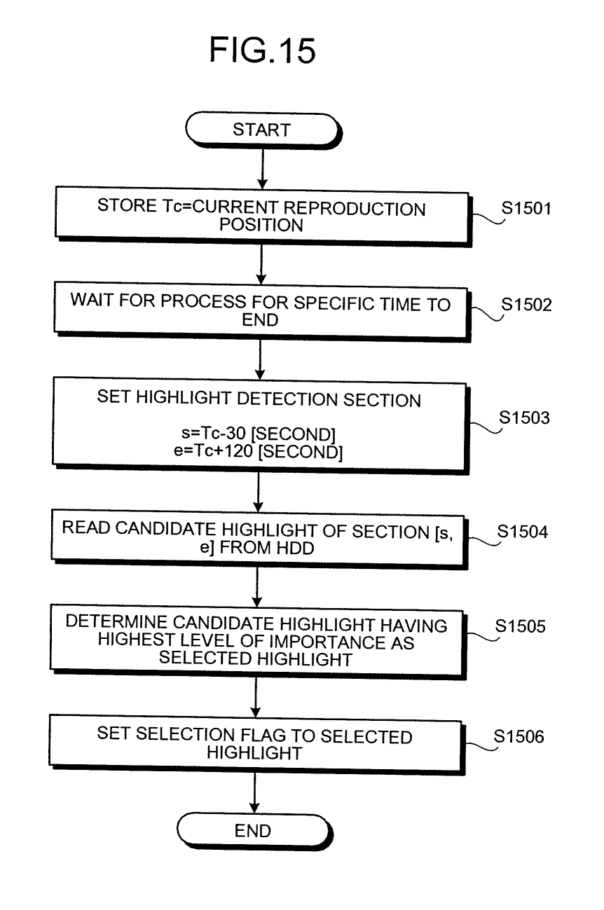

Whether an instruction for a highlight event has been received is determined (step S1304). When an instruction for a highlight event has been received (step S1304: YES), a highlight detecting process shown in FIG. 15 is executed (step S1305). When no instruction for a highlight event has been received (step S1304: NO), or after the highlight detecting process has ended, whether the reception of the program has ended is determined (step S1306). When the reception of the program has not ended (step S1306: NO), the process returns to step S1301 and re-starts. When the reception has ended (step S1306: YES), the series of processing comes to an end.

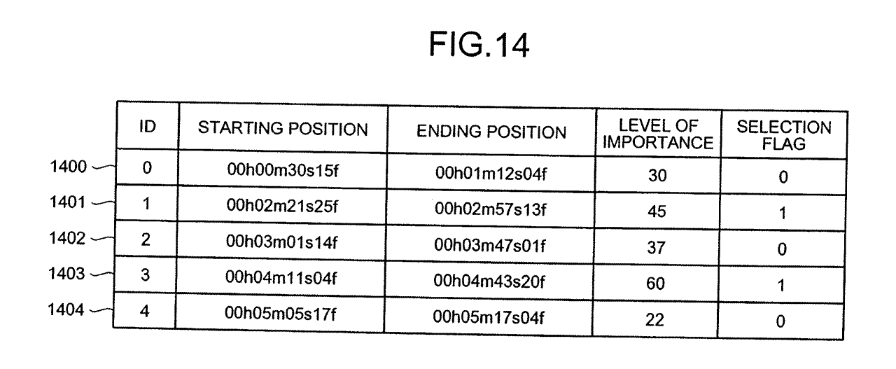

FIG. 14 is a diagram for explaining the starting position and the ending position of the highlight scene, and the degree of importance thereof. The starting position and the ending position of each vehicle stop time, the degree of importance, and a selection flag are recorded corresponding to an ID. “Selection flag” means whether a highlight scene is selected by the viewer. In this case, “0” means a candidate highlight scene and “1” means a selected highlight scene instructed by the viewer.

Data 1400 to 1404 each record the starting position and ending position and are corresponding assigned IDs 0 to 4. However, the starting position and the ending position of subsequent highlight scenes can be recorded by preparing IDs 5, 6, and etc., i.e., the ID number is incremented by one each time a new highlight scene is detected. FIG. 14 is an example of highlight scene information detected in this manner. An ID is a number given to identify each highlight scene. An ending time may be recorded in the form of duration of a highlight scene.

The data 1400 is recorded corresponding to the ID 0 and the starting position thereof is 00h00m30s15f. The ending position thereof is 00h01m12s04f. The degree of importance thereof is 30. The selection flag thereof is 0.

The data 1401 is recorded corresponding to the ID 1 and the starting position thereof is 00h02m21s25f. The ending position thereof is 00h02m57s13f. The degree of importance thereof is 45. The selection flag is 1. The data 1402 is recorded corresponding to the ID 2 and the starting time thereof is 00h03m01s14f. The ending time thereof is 00h03m47s01f. The degree of importance thereof is 37. The selection flag is 0. The data 1403 is recorded being corresponded to the ID 3 and the starting time thereof is 00h04m11s04f. The ending time thereof is 00h04m43s20f. The degree of importance thereof is 60. The selection flag thereof is 1. The data 1404 is recorded being corresponded to the ID 4 and the starting time thereof is 00h05m05s17f. The ending time thereof is 00h00m00s00f. The degree of importance thereof is 22. The selection flag thereof is 0.

FIG. 15 is a flowchart for explaining a highlight detecting process executed in response to the instruction of a highlight event. “Tc” is stored as the current reproduction position (step S1501). A process, for a specific time, is waited for to end (step S1502). Thereby, the start of the highlight detecting process is delayed. By delaying the start, the end of a candidate highlight is waited for and the starting time and the ending time of the candidate highlight can be detected.

A highlight detection section is set (step S1503). In this case, the starting time of the highlight detection is denoted by “s” and the ending time of the highlight detection is denoted by “e”. As to the highlight detection section, it is assumed, for example, s=Tc-30 sec and e=Tc-120 sec. These lengths can each be variously set according to the application. A candidate highlight of a section [s, e] is read from the HDD 331 (step S1504). The candidate highlight having the highest degree of importance is assumed as a selected highlight (step S1505). A selection flag is set for the selected highlight (step S1506). For example, the selection flag thereof is set to be 1. After this setting, the series of processing comes to an end.

In the first embodiment, the attribute level necessary for the detection of the highlight scene is stored. Therefore, the selection of a more optimal highlight detection approach corresponding to the situation is enabled. Although the extracted attribute level data must be stored, the data amount is overwhelmingly small compared to image data. One method of reducing the data amount to be recorded in the HDD can be detecting a highlight scene in real time and recording the scene in the HDD. However, a problem has arisen in that as highlight detection relies completely on a highlight detection algorithm of the system, highlights can not be detected at the timing that the viewer desires, i.e., the timing according to the highlight event instruction.

With respect to this problem, as shown by a fifth embodiment, the highlight scene can be detected and the degree of importance thereof can also be detected and both can be recorded into the HDD 331. That is, in real time, the candidate highlight scene and the degree of importance of the highlight scene are detected and recorded into the HDD 331. In this case, for the detection of the highlight scene, overlooked highlight scenes can be reduced by setting a lower threshold value to detect a greater number of highlight scenes. When the highlight event is instructed, the candidate highlight scene having the highest degree of importance in the highlight detection section is taken as the desired highlight scene. In this case, the specific method of assigning the degree of importance to a highlight scene is not limited. An approach thereof can be an approach according to which a section having a high sound level that continues at a higher level, a section having a sound level at a higher value, and a section after a long soundless section are determined as highlight scenes each having a high degree of importance.

In this manner, a highlight scene that is close to the instructed time is detected in response to the highlight event instruction from the viewer. In this case, the detection conditions of the detected highlight scene are further stored and, thereafter, when a highlight scene that is close to the conditions is detected, a highlight scene may be automatically determined.

According to the first to fifth embodiments above, an instruction can be received at a specific timing and a highlight scene can be determined using the instructed timing as a hint. The highlight scene can be reproduced later. For example, an instruction can be received while a vehicle is in a traveling state and the highlight scene can be reproduced while the vehicle is in a stopped state. Thereby, viewing the content can be supported in a manner that is not disruptive to the operation of the vehicle by the driver.

During replay reproduction, even when a program can not be viewed, the program can be viewed as a highlight scene by instruction after the replay reproduction. Hence, even when scenes are present that the viewer has failed to view during the replay, the scenes can be viewed as a highlight reproduction and missed scenes during intermittent viewing can be minimized.

A highlight scene can be designated by an instruction of the viewer when the scene can not be viewed due to driving or execution of replay. Therefore, for example, a computer is prevented from unilaterally determining a highlight scene and an appropriate highlight scene can be viewed in a state according to the needs of the viewer.

The recording and reproducing method described in the embodiments can be realized by a computer such as a personal computer, a work station, etc. executing a program that is prepared in advance. This program is recorded in a computer-readable recording medium such as a hard disk, a flexible disk, a CD-ROM, an MO, a DVD, etc., and is executed by being read from the recording medium by the computer. This program may be a transmission medium distributable through a network such as the Internet, etc.

1.-12. (canceled)

13. A recording and reproducing apparatus comprising:
a determining unit that determines whether a vehicle is in a traveling state or a stopped state;
an indicating unit that indicates, while the vehicle is in the traveling state, a timing of a point in content that is to be reproduced;
a specifying unit that specifies a representative scene in the content that is in immediate proximity to the timing indicated by the indicating unit; and
a reproducing unit that reproduces the representative scene while the vehicle is in the stopped state.

14. The recording and reproducing apparatus according to claim 13, wherein
the specifying unit determines, for each scene included in the content, whether the scene is a characteristic scene, and specifies an interval of consecutive characteristic scenes as the representative scene.

15. The recording and reproducing apparatus according to claim 14, wherein
the specifying unit extracts an attribute level of each scene included in the content and determines the characteristic scene based on the attribute level.

16. The recording and reproducing apparatus according to claim 13, wherein
the specifying unit, to specify the representative scene, determines for each scene after a given point, whether the scene is a characteristic scene, the given point immediately preceding the timing by a predetermined interval.

17. The recording and reproducing apparatus according to claim 13, wherein
the determining unit records the time of each vehicle stop, and
the reproducing unit reproduces a representative scene that is after the time of the previous vehicle stop.

18. The recording and reproducing apparatus according to claim 13 further comprising:
an obtaining unit that obtains travel information of the vehicle;
an estimating unit that estimates a duration of the stopped state based on the travel information;
a shortening unit that shortens the representative scene to a length reproducible within the duration of the stopped state, wherein
the reproducing unit reproduces the representative scene shortened by the shortening unit.

19. The recording and reproducing apparatus according to claim 13 further comprising:
a recording unit that records the content; and
a detecting unit that detects a degree of importance of the content recorded by the recording unit, wherein
the specifying unit specifies the representative scene based on the degree of importance.

20. A recording and reproducing method comprising:
determining whether a vehicle is in a traveling state or a stopped state;
indicating, while the vehicle is in the traveling state, a timing of a point in content that is to be reproduced;
specifying a representative scene in the content that is in immediate proximity to the timing indicated by the indicating unit; and
reproducing the representative scene while the vehicle is in the stopped state.

21. A computer-readable recording medium storing therein a recording and reproducing program that causes a computer to execute:
determining whether a vehicle is in a traveling state or a stopped state;
indicating, while the vehicle is in the traveling state, a timing of a point in content that is to be reproduced;
specifying a representative scene in the content that is in immediate proximity to the timing indicated by the indicating unit; and
reproducing the representative scene while the vehicle is in the stopped state.
